(19) United States
(12) Patent Application Publication
(10) Pub. No.: US 2023/0082548 A1
(43) Pub. Date: Mar. 16, 2023

(54) Air Pump with Relief Device

(71) Applicant: Scott Wu, Taichung City (TW)

(72) Inventor: Scott Wu, Taichung City (TW)

(21) Appl. No.: 17/472,931

(22) Filed: Sep. 13, 2021

(51) Int. Cl. F04B 49/24; F04B 53/10

(52) U.S. Cl. CPC F04B 49/24; F04B 53/10

(57) ABSTRACT

A relief device in air pump includes a main body defining an interior space and a discharge hole fluidly communicating with the interior space. The discharge hole is selectively closed and opened by a valve device. The valve device is movable in the discharge hole. The discharge hole includes a first air sealing structure and the valve device includes a second air sealing structure and a third air sealing structure adapted to selectively contact with the first air sealing structure to prevent air flowing outside of the main body through the discharge hole and in addition at least one pressure releasing structure, located between the second and the third air sealing structures, adapted to cooperate with the first air sealing structure to delimit a gap therebetween for air to flow outside of the main body.

### BACKGROUND OF THE INVENTION

### 1. Field of the Invention

The present invention relates to an air pump and, particularly, to a relief device configured for dispensing a trace amount of air from the air pump.

### 2. Description of the Related Art

TW Pat. No. M566758 shows an air pump including a holding seat, a pumping assembly, a joint head assembly, and a pressure gage. The holding seat has a hollow housing. The pumping and the joint head assemblies are respectively disposed at an inlet end and an outlet end of the housing. The holding seat defines a measuring portion and the pressure gage is disposed at the measuring portion. The housing is engaged with a connecting end of the joint head assembly through a connection which includes at least one positioning block engaging in at least one positioning slot. The at least one positioning block extends through the housing and the connecting end.

Further, the air pump includes a pressure relief for decreasing the pressure of the air pump if the pressure exceeds a predetermined value. Specifically, as long as the pressure relief is activated, the pressure of the air pump continues to decrease and so the user needs to control the pressing time to adjust the amount of pressure decrease. Nevertheless, it is difficult to achieve a fine adjustment of the pressure.

The present invention is, therefore, intended to obviate or at least alleviate the problems encountered in the prior art.

### SUMMARY OF THE INVENTION

According to the present invention, a relief device in air pump is configured for dispensing a trace amount of air from the air pump. The air pump has a main body which defines an interior space and a discharge hole fluidly communicating with each other. The discharge hole extends from a first end adjacent to the interior space to a second end which fluidly communicates with the outside of the main body. The discharge hole is selectively closed and opened to the outside of the main body by a valve device. The discharge hole includes a first air sealing structure and the valve device includes a second air sealing structure and a third air sealing structure adapted to selectively contact with the first air sealing structure to prevent air flowing outside of the main body through the discharge hole and in addition at least one pressure releasing structure, located between the second and the third air sealing structures, adapted to cooperate with the first air sealing structure to delimit a gap therebetween for air to flow outside of the main body. The valve device is movable between a first position in which the second air sealing structure contacts with the first air sealing structure, a second position in which the third air sealing structure contacts with the first air sealing structure, and a third position in which the second and the third air sealing structures are disposed away from the first air sealing structure and the at least one pressure releasing structure cooperates with the first air sealing structure. The second and the third air sealing structures and the at least one pressure releasing structure are adapted to move in and out of the discharge hole. The at least one pressure releasing structure is of a smaller width than the second and the third air sealing structures.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of an air pump with a relief device in accordance with the present invention, with the relief device configured for dispensing a trace amount of air.

FIG. 2 is an exploded perspective view of the relief device.

FIG. 3 is a cross-sectional view showing the relief device in a first position.

FIG. 4 is a cross-sectional view showing the relief device in a third position.

FIG. 5 is a cross-sectional view showing the relief device in a second position.

### DETAILED DESCRIPTION OF THE INVENTION

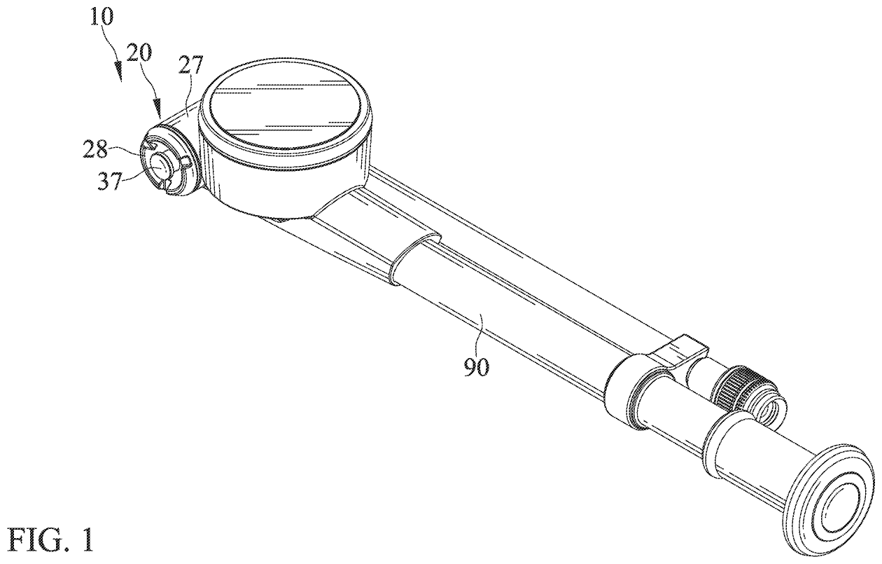

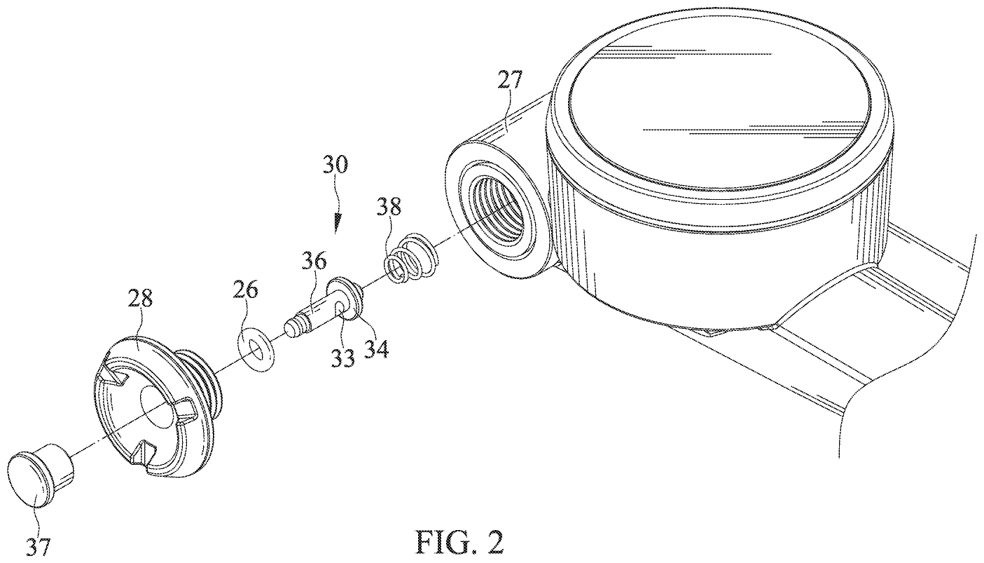

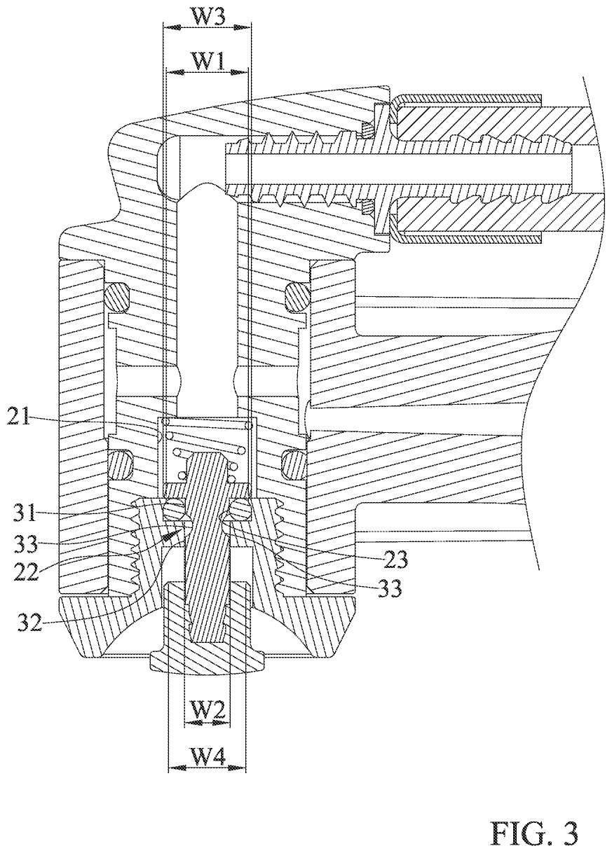

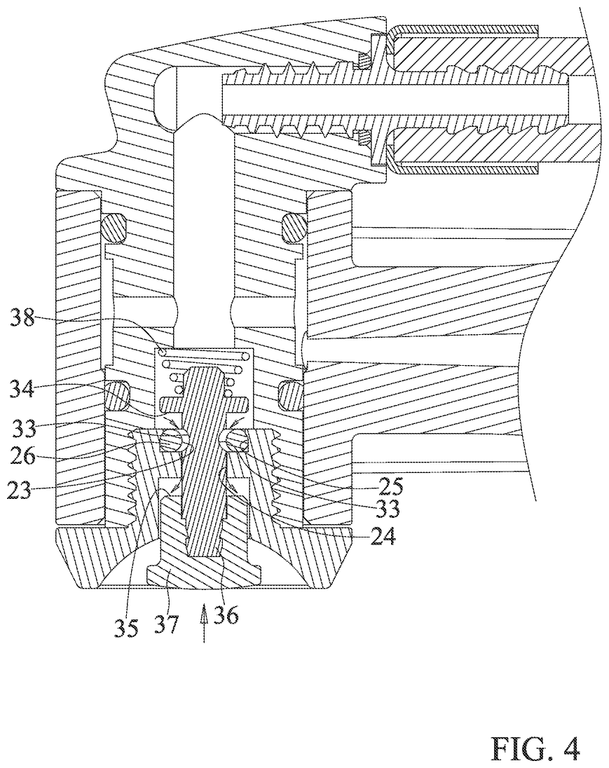

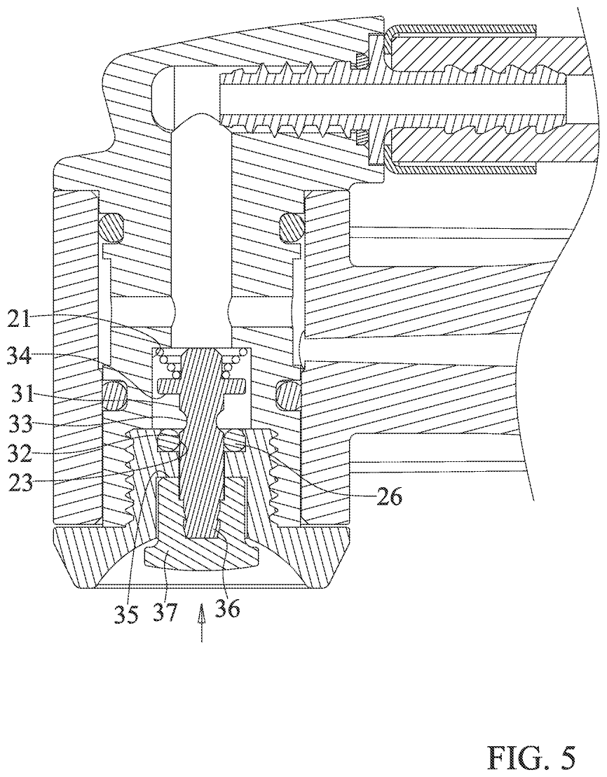

FIGS. 1 through 5 show an air pump 90 with a relief device 10 configured for dispensing a trace amount of air from the air pump in accordance with the present invention.

The relief device 10 includes a main body 20 which defines an interior space 21 and a discharge hole 22 fluidly communicating with each other. The main body 20 forms a valve seat 27 defining the interior space 21. Air will flow into the interior space 21 upon the operation of the air pump 90. The discharge hole 22 extends from a first end adjacent to the interior space 21 to a second end which fluidly communicates with the outside of the main body 20. The main body 20 includes a cap 28 coupled thereto for retaining the valve device 30 in the main body 20. The cap 28 is coupled to the valve seat 27. The cap 28 defines the discharge hole 22. The discharge hole 22 has a wide section 24 and a narrow section 25 having a smaller width than the wide section 24. The wide section 24 is of a width W1 and the narrow section 25 is of a width W2, respectively. The wide section 24 is disposed between the interior space 21 and the narrow section 25 and has a first end opening to the interior space 21 and a second end opening to the narrow section 25. The wide section 24 includes a seal gasket 26 retained therein. The seal gasket 26 includes a first lateral side facing a periphery of the wide section 24. The first lateral side of the seal gasket 26 extends curvedly. The periphery of the wide section 24 extends curvedly. In the embodiment, the first lateral side of the seal gasket 26 abuts the periphery of the wide section 24. Further, the seal gasket 26 abuts a wall extending radially from the periphery of the wide section 24 to a periphery of the narrow section 25.

The discharge hole 22 is selectively closed and opened to the outside of the main body 20 by a valve device 30. The discharge hole 22 includes a first air sealing structure 23 and the valve device 30 includes a second air sealing structure 31 and a third air sealing structure 32 adapted to selectively contact with the first air sealing structure 23 to prevent air flowing outside of the main body 20 through the discharge hole 22 and in addition at least one pressure releasing structure 33, located between the second and the third air sealing structures 31 and 32, adapted to cooperate with the first air sealing structure 23 to delimit a gap therebetween for air to flow outside of the main body 20. In the embodiment, the seal gasket 26 includes a second lateral side forming the first air sealing structure 23. The at least one pressure releasing structure 33 delimits a recess, and the first air sealing structure 23 has a side adapted to cooperate with the recess to delimit the gap. The recess of the pressure releasing structure 33 is concave. In the embodiment, the at least one pressure releasing structure 33 includes two pressure releasing structures 33, which are disposed oppositely.

The valve device 30 is movable between a first position in which the second air sealing structure 31 contacts with the first air sealing structure 23, a second position in which the third air sealing structure 32 contacts with the first air sealing structure 23, and a third position in which the second and the third air sealing structures 31 and 32 are disposed away from the first air sealing structure 23 and the at least one pressure releasing structure 33 cooperates with the first air sealing structure 23. The second and the third air sealing structures 31 and 32 and the at least one pressure releasing structure 33 are adapted to move in and out of the discharge hole 22. The at least one pressure releasing structure 33 is of a smaller width than the second and the third air sealing structures 31 and 32.

The valve device 30 includes a first retaining side 34 and a second retaining side 35. The valve device 30 is retained at the first position in which the first retaining side 34 abuts the first end of the discharge hole 22. The valve device 30 is retained at the second position in which the second retaining side 35 abuts the second end of the discharge hole 22. The first retaining side 34 is of a greater width than the wide section 24. The second retaining side 35 is of a greater width than the narrow section 25. The first retaining side 34 is of a width W3 and the second retaining side 35 is of a width W4, respectively.

The valve device 30 includes a moving member 36 forming the second and the third air sealing structures 31 and 32. The moving member 36 is urged by a resilient member 38. The valve device 30 also includes a control 37 configured to be actuated to push the moving member 36. The control 37 has an end being exposed for receiving an input from a user.

In view of the foregoing, the discharge hole 22 is selectively closed and opened to the outside of the main body 20 by the valve device 30. When the valve device 30 is moved to the first or the second positions, the discharge hole 22 is closed. When the valve device 30 is moved to the first and the second positions, the discharge hole 22 is closed. When the valve device 30 is moved to the third position, the discharge hole 22 is opened to allow a trace amount of air from the air pump 90 to be dispensed.

The foregoing is merely illustrative of the principles of this invention and various modifications can be made by those skilled in the art without departing from the scope and spirit of the invention.

What is claimed is:

1. A relief device configured for dispensing a trace amount of air from an air pump, comprising:
a main body defining an interior space and a discharge hole fluidly communicating with each other, wherein the discharge hole extends from a first end adjacent to the interior space to a second end which fluidly communicates with the outside of the main body, wherein the discharge hole is selectively closed and opened to the outside of the main body by a valve device, wherein the discharge hole includes a first air sealing structure and the valve device includes a second air sealing structure and a third air sealing structure adapted to selectively contact with the first air sealing structure to prevent air flowing outside of the main body through the discharge hole and in addition at least one pressure releasing structure, located between the second and the third air sealing structures, adapted to cooperate with the first air sealing structure to delimit a gap therebetween for air to flow outside of the main body, wherein the valve device is movable between a first position in which the second air sealing structure contacts with the first air sealing structure, a second position in which the third air sealing structure contacts with the first air sealing structure, and a third position in which the second and the third air sealing structures are disposed away from the first air sealing structure and the at least one pressure releasing structure cooperates with the first air sealing structure, wherein the second and the third air sealing structures and the at least one pressure releasing structure are adapted to move in and out of the discharge hole, and wherein the at least one pressure releasing structure is of a smaller width than the second and the third air sealing structures.

2. The relief device as claimed in claim 1, wherein the discharge hole has a wide section and a narrow section having a smaller width than the wide section, wherein the wide section is disposed between the interior space and the narrow section and has a first end opening to the interior space and a second end opening to the narrow section, wherein the wide section includes a seal gasket retained therein, and wherein the seal gasket includes a first lateral side facing a periphery of the wide section and a second lateral side forming the first air sealing structure.

3. The relief device as claimed in claim 2, wherein the discharge hole includes a wall extending radially from the periphery of the wide section to a periphery of the narrow section, and wherein the seal gasket abuts the wall.

4. The relief device as claimed in claim 3, wherein the first lateral side of the seal gasket abuts the periphery of the wide section.

5. The relief device as claimed in claim 1, wherein the at least one pressure releasing structure delimits a recess, and wherein the first air sealing structure has a side adapted to cooperate with the recess to delimit the gap.

6. The relief device as claimed in claim 5, wherein the recess of the at least one pressure releasing structure is concave.

7. The relief device as claimed in claim 1, wherein the at least one pressure releasing structure includes two pressure releasing structures, which are disposed oppositely.

8. The relief device as claimed in claim 1, wherein the valve device includes a first retaining side and a second retaining side, wherein the valve device is retained at the first position in which the first retaining side abuts the first end of the discharge hole, and wherein the valve device is retained at the second position in which the second retaining side abuts the second end of the discharge hole.

9. The relief device as claimed in claim 8, wherein the discharge hole has a wide section and a narrow section having a smaller width than the wide section, wherein the wide section is disposed between the interior space and the narrow section and has a first end opening to the interior space and a second end opening to the narrow section wherein the first retaining side is of a greater width than the wide section, and wherein the second retaining side is of a greater width than the narrow section.

10. The relief device as claimed in claim 9, wherein the wide section includes a seal gasket retained therein, and wherein the seal gasket includes a first lateral side facing a periphery of the wide section and a second lateral side forming the first air sealing structure.

11. The relief device as claimed in claim 10, wherein the discharge hole includes a wall extending radially from the periphery of the wide section to a periphery of the narrow section, and wherein the seal gasket abuts the wall.

12. The relief device as claimed in claim 11, wherein the first lateral side of the seal gasket abuts the periphery of the wide section.

13. The relief device as claimed in claim 1, wherein the valve device includes a moving member forming the second and the third air sealing structures.

14. The relief device as claimed in claim 13, wherein the valve device includes a control configured to be actuated to push the moving member, and wherein the control has an end being exposed for receiving an input from a user.

15. The relief device as claimed in claim 13, wherein the moving member is urged by a resilient member.

16. The relief device as claimed in claim 15, wherein the valve device includes a first retaining side and a second retaining side, wherein the valve device is retained at the first position in which the first retaining side abuts the first end of the discharge hole, wherein the valve device is retained at the second position in which the second retaining side abuts the second end of the discharge hole, and wherein the resilient member has an end abutting the first retaining side.

17. The relief device as claimed in claim 1, wherein the main body includes a cap coupled thereto for retaining the valve device in the main body.

18. The relief device as claimed in claim 17, wherein the cap defines the discharge hole.

19. The relief device as claimed in claim 18, wherein the main body forms a valve seat defining the interior space and the cap is coupled to valve seat.

20. The relief device as claimed in claim 19, wherein the valve device includes a first retaining side and a second retaining side, wherein the valve device is retained at the first position in which the first retaining side abuts the first end of the discharge hole, wherein the valve device is retained at the second position in which the second retaining side abuts the second end of the discharge hole, and wherein the resilient member has an end abutting the first retaining side.
